(19) United States
(12) Patent Application Publication
(10) Pub. No.: US 2025/0265477 A1
(43) Pub. Date: Aug. 21, 2025

(54) KNOWLEDGE GRAPH CREATION AND USE

(71) Applicant: MICROSOFT TECHNOLOGY LICENSING, LLC, Redmond, WA (US)

(72) Inventors: Mahdi Pakdaman NAEINI, Kirkland, WA (US); Liang DU, Redmond, WA (US); Neda ROHANI, Bellevue, WA (US)

(21) Appl. No.: 18/595,397

(22) Filed: Mar. 4, 2024

Related U.S. Application Data
(60) Provisional application No. 63/555,367, filed on Feb. 19, 2024.

(51) Int. Cl. G06N 5/02; G06N 5/04

(52) U.S. Cl. CPC G06N 5/02; G06N 5/04

(57) ABSTRACT

This disclosure introduces a novel method and system for making a knowledge graph. A relation classification model is used to classify relationships between entities found in natural-language text. These entities become the nodes and the relationships between them become the edges in the knowledge graph. The entities are specific items that are relevant to the subject matter of the natural-language text. If the natural language documents are biomedical texts, the entities may be things such as chemicals, diseases, and genes. The relation classification model uses a transformer-based deep neural network architecture to understand the meaning of the text that contains the entities. The relation classification model also includes a classification layer that classifies the type of relationship between the entities found in the texts. With the knowledge graph, a user can efficiently receive answers to questions based on the aggregate knowledge found in many different documents.

### PRIORITY APPLICATION

This application claims the benefit of and priority to U.S. Provisional Application No. 63/555,367, filed Feb. 19, 2024, the entire contents of which are incorporated herein by reference.

### BACKGROUND

The biomedical research landscape is rapidly evolving, necessitating up-to-date and accurate knowledge representation for effective scientific discovery. PubMed, one repository for biomedical research articles, adds 4,000 new papers every day and over a million every year. It is impossible to keep track of such rapid progress by manual efforts alone. In the era of big data and precision medicine, the urgency has never been higher to advance natural language processing (NLP) methods that can help scientists stay versed in the deluge of information. NLP can help researchers quickly identify and cross-reference important findings in papers that are both directly and tangentially related to their own research at a large scale-instead of manually sifting through papers for relevant findings or recalling them from memory.

It is also impractical for researchers to access all this knowledge directly even if they have time to manually review thousands of papers. Many of these resources are now available in electronic form from a network or a cloud-based computing system. Downloading multiple research articles, or even accessing the full text of those articles on a user device, can consume significant network bandwidth as well as memory. Techniques to identify only the most relevant information for a given query and return that information alone can reduce consumption of network bandwidth and local storage. Most researchers and scientists do not need to review the full text of multiple articles. Rather, they need a concise answer to a question that may synthesize data from a large number of different documents. Improvements in the curation and NLP of biomedical research can make it easier for researchers to find accurate answers to their queries and efficiently obtain this information on a user device. This disclosure is made with respect to these and other considerations.

### SUMMARY

This disclosure pertains to the use of a knowledge graph, more specifically a biomedical knowledge graph (BKG), to facilitate finding information contained in multiple documents such as biomedical research articles. A knowledge respect to is a structured way of representing knowledge, where entities are nodes and the relationships between them are edges. A BKG is a multi-relational graph or network that integrates, harmonizes, and stores biomedical knowledge acquired from expert-derived knowledge sources such as research articles. For biomedical knowledge, the entities may be things such as chemicals (i.e., drugs), diseases, and genes. However, the specific type of entities can vary and will be different for different subject matter areas.

A BKG can be used in various ways in the field of biomedical research. For example, researchers can use it to explore complex relationships between different biomedical entities, which can aid in tasks like drug discovery, disease diagnosis, and treatment optimization. Users can query a knowledge graph with an entity (e.g., a gene) and receive results that identify other entities with a specific type of relation to that entity (e.g., diseases that may be caused by mutations in that gene).

NLP is used to identify entities within a corpus of documents, such as biomedical research articles, and to determine the probability of different types of relationships between the entities. Thereby identifying the nodes and edges that will make up the knowledge graph. To do this, the text of a corpus of documents is analyzed to understand how entities (e.g., a chemical and a disease) are related. For example, a chemical may be identified as a treatment for a disease, or a disease may be identified as a side effect from taking a chemical. These relationships are recorded in the knowledge graph and thus the knowledge graph enables researchers to identify relationships based on the aggregated knowledge found in multiple documents.

The techniques of this disclosure use a novel relation classification model to label relationships between entities found in a corpus of documents. The relation classification model uses a transformer-based deep neural network (DNN) architecture to understand the meaning of natural language. The DNN may be specifically trained on documents that contain the same general subject matter as the corpus of documents to be analyzed by the relation classification model. For example, to analyze biomedical documents, a BERT-based transformer model pretrained on biomedical text may be used. The relation classification model also includes a classification layer which can be implemented as a softmax layer. The classification layer together with the DNN determines the probability of the relationship between entities as falling into each of several relationship classes. These relationship classes are determined in advance and represent possible types of relationships between specific types of entities. For example, the entity types of chemical and disease could have a relationship type that is one of treatment, side effect, prevents, or alleviates. The specific relationship classes will vary depending on the design of the model and the types of entities considered.

This relation classification model is trained on a labeled training data set that includes training sentences that are labeled with a relationship class distribution. The relationship class distribution indicates which type of relationship between the named entities is most likely described by each of the training sentences. The sentences in this training data set have the actual names of the entities replaced by masks so that the model learns the meaning of the other words without influence from the particular name of a masked entity such as a chemical, disease, or gene. The training relationship class distribution may be a label that is created manually or found by another NLP technique. Given a fixed number of possible relationship classes for the entities, relationship class distribution provides a probability that the language of a given sentence represents each of these types of relationship classes.

As a simple example, for a sentence that includes a chemical and a disease, the NLP systems could estimate a 90% probability of the sentence describing a treatment relationship (i.e., the chemical is a treatment for the disease) and 10% probability of a side effect relationship (i.e., the disease is a side effect of taking the chemical). Although a human would likely be able to unambiguously identify the type of relationship conveyed by the text of the sentence, the relative probabilities may be due to the limitations of NLP as well as conflicting information in the source documents. The training modifies weights in the classification layer so that the relation classification model learns to predict relationship class distributions that are similar to those in the training data.

A knowledge graph encoding relationships identified by the relation classification model can receive a query that includes a first named entity (e.g., a chemical, a disease, or a gene) and a second named entity or a relationship class. For example, a query could ask which genes promote progression of a disease. Alternatively, a query could ask what type of relationships exist between a chemical and a gene. The query is submitted to the knowledge graph and the type of relationships or entities requested in the query are identified from the nodes and edges of the knowledge graph. An answer to the query is provided based on the information in the knowledge graph. The answer identifies a type of relationship between the first named entity and the second named entity or identifies entities that share the specified type of relationship with the first named entity. The answer may be a single sentence, a short list or table, or some other format. The answer is smaller in size than the corresponding documents from which the knowledge in the result was identified. This makes it easier to transmit the answer across a network and to store the result on a computing device of the user compared to providing direct access to the full text of the documents in the corpus of documents.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a diagram showing the use of a relation classification model to create a knowledge graph from a corpus of documents.

FIG. 2 is a diagram showing an architecture for the relation classification model.

FIG. 3 is a flowchart of a method for training a relation classification model.

FIG. 4 is a flowchart of a method for creating a knowledge graph with a relation classification model.

FIG. 5 is a flowchart of a method for using a knowledge graph to generate an answer in response to a query.

FIG. 6 is a computer architecture diagram illustrating an illustrative computer hardware and software architecture for a computing device capable of implementing aspects of the techniques and technologies presented herein.

FIG. 7 is a diagram illustrating a distributed computing environment capable of implementing aspects of the techniques and technologies presented herein.

### DETAILED DESCRIPTION

This disclosure predominantly describes examples in the context of biomedical texts but is broadly applicable to any genre of subject matter. The network of interactions among biomedical entities-chemicals, diseases, and genes—has long been of interest to biomedical researchers. Over the years, scientific curators have painstakingly excavated these relationships from the unstructured text of research articles, translating natural language descriptions into structured, machine-computable data. Manual curation provides researchers and clinicians with cross-sectional, domain-specific views of the literature. These relationships offer insights into the mechanisms behind higher order biochemical phenomena, such as drug-drug interactions and variations in drug response across individuals. However, as the literature grows, manual curation becomes increasingly time-consuming and expensive. It also limits the nature of questions that can be asked of the literature to those for which personnel and funding are available. Thus, automated techniques using NLP are necessary to fully capture the information contained in a large corpus of documents such as all the published scientific literature.

As mentioned above, relationships between entities found in unstructured texts can be identified and represented in a knowledge graph or, for biomedical knowledge, a BKG. BKGs are graphical representations of relationships between various biomedical entities such as genes, proteins, diseases, drugs/chemicals, biological processes, etc. These knowledge graphs serve as an important tool for assimilating and analyzing vast amounts of biomedical data from diverse sources, generating novel hypotheses, and driving advancements in biomedical research.

The utility of BKGs in the field of biomedical research is multifaceted, offering numerous benefits to researchers. For example, they can be employed in investigating pathogenesis, examining disease similarity, improving diagnosis, studying phenotyping, and promoting precision medicine. BKGs also play a significant role in exploring treatments, analyzing drug-disease relationships, identifying drug repurposing opportunities, understanding drug action mechanisms, and understanding drug resistance. They facilitate drug discovery by identifying potential toxicants and detecting adverse events. Furthermore, BKGs can be used to mine information from scientific publications, identify relevant research articles, and extract essential facts or relationships from textual data.

Despite the emergence of Large Language Models (LLMs), BKGs continue to offer unique advantages that make them valuable in the field of biomedical research. One of the primary reasons is that BKGs are grounded in factual knowledge bases, whereas LLMs often are subject to hallucination and may not always provide accurate information. Moreover, knowledge graphs exhibit superior efficiency in handling historical data. They can be specifically designed to provide customized time-point snapshots based on user requests, ensuring that researchers have access to the most relevant information for their work. In contrast, LLMs may struggle with managing and presenting data from various time periods coherently. Another aspect where BKGs excel over LLMs is in their ease of maintenance to ensure up-to-date information. Knowledge graphs can be conveniently updated, corrected, and fine-tuned based on internal data and feedback, preserving the accuracy and relevance of the information they contain. Conversely, fine-tuning LLMs often leads to the forgetting of previously acquired knowledge, which can hinder the model's overall performance and reliability.

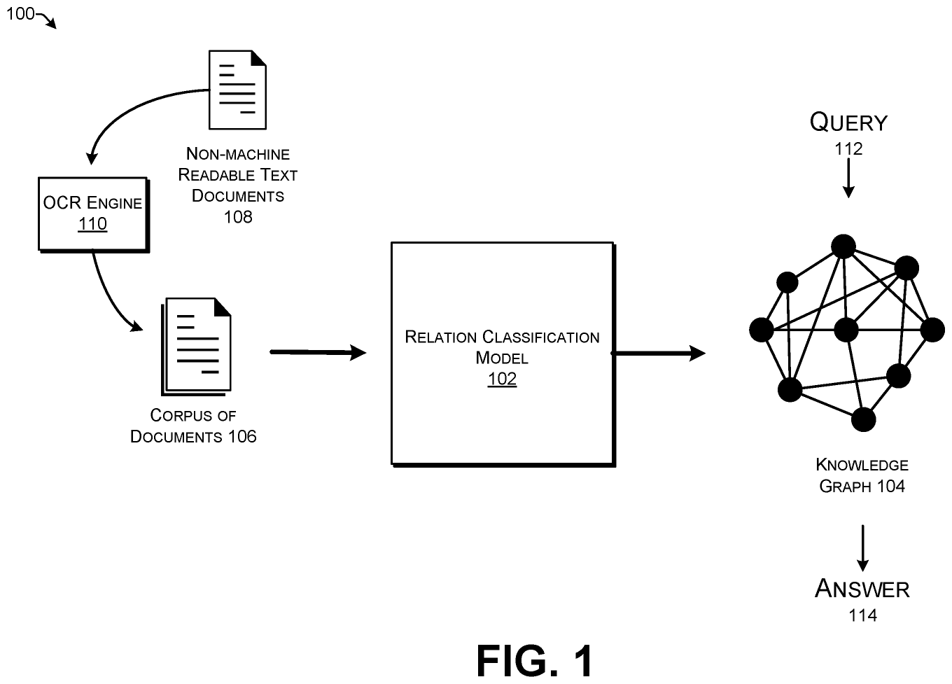

FIG. 1 is a diagram 100 showing use of a relation classification model 102 for the generation of a knowledge graph 104 that represents knowledge extracted from a corpus of documents 106. The pipeline for creation of knowledge graph 104 typically involves several stages including data collection, data preprocessing, entity recognition, relationship extraction, and graph construction. In some implementations, this pipeline involves extracting information from biomedical literature and representing it in a structured, interconnected format. The pipeline uses deep learning-based Machine Learning (ML)/NLP implemented in the relation classification model 102, which helps to reduce parsing errors and improve the accuracy and comprehensiveness of the knowledge graph 104 compared to other techniques. Deep learning-based ML/NLP relation classification models are advanced computational models that are used to identify and classify relationships between entities in text data.

The corpus of documents 106 can be any collection of natural language text and may include unstructured documents. In some implementations, the corpus of documents 106 all relate to a specific topic or contain information in the same domain such as, for example, biomedical texts. One source of biomedical texts that is available on the Internet is PubMed. PubMed is a search engine primarily accessing the MEDLINE database, which contains references and abstracts on life sciences and biomedical topics. Maintained by the United States National Library of Medicine at the National Institutes of Health, it serves as a resource for both professionals in the field and the general public interested in biomedical research. PubMed is available on the World Wide Web at pubmed.ncbi.nlm.nih.gov. It can also be accessed via several public APIs. Biomedical literature may also be obtained from other databases besides PubMed such as Scopus, Web of Science, ScienceDirect, and Ovid.

The corpus of documents 106 includes the natural language text in a machine-readable format so that the content of the documents can be analyzed by computer systems such as the relation classification model 102. For example, if the corpus of documents 106 represents a resource stored on the Internet, the documents may be in XML or a similar markup language. Any other format used for storing natural language text, in any human language, in a format that can be processed by machines is also suitable such as text format, open document format, and portable document format. There are also non-machine readable text documents 108 such as documents printed on paper or documents in which the text is stored as an image or otherwise not directly recognizable by a computer. These non-machine readable text documents 108 may contain valuable information that, if included, would contribute to the knowledge graph 104. In order to add non-machine readable text documents 108 to the corpus of documents 106, they may be processed by passing them through an optical character recognition (OCR) engine 110 that generates machine-readable text which can be added to the corpus of documents 106.

The corpus of documents 106 is analyzed by the relation classification model 102. However, the corpus of documents 106 may undergo preprocessing before it is passed to the relation classification model 102. One type of preprocessing is sentence segmentation. Sentence segmentation is a fundamental task in NLP that involves dividing a text into its constituent sentences, a process complicated by the ambiguity of punctuation marks. The text of the documents in the corpus of documents 106 is divided into discrete sentences. Thus, rather than analyzing a document as a whole, each sentence can be analyzed separately. Existing tools like BlingFire by Microsoft® or NLP toolkits like SpaCy or Stanford NLTK can be used to perform text tokenization and sentence breaking.

The next processing that may be performed on the text from the corpus of documents 106 is named entity recognition (NER). NER is a subtask of information extraction that seeks to locate and classify named entities mentioned in unstructured text into predefined categories. These categories can include person names, organizations, locations, medical codes, time expressions, quantities, monetary values, percentages, etc. PubTator is one example of a NER tool used for biomedical name entity recognition. PubTator is an automated, web-based system that processes PubMed abstracts and assigns entities to predefined categories such as chemicals, genes, diseases, species, etc. It employs deep learning models trained on curated corpora for accurate recognition and classification of biomedical entities, ensuring high precision and recall.

Thus, with these types of preprocessing the corpus of documents 106 is divided into sentences and named entities are identified in the sentences. Each sentence may potentially describe a type of relationship for any named entities mentioned in that sentence. The type of possible relationships can vary based on the entities that are considered. In some implementations, there will only be two entities considered when determining a type relationship between them. For biomedical texts, the named entities could be disease, chemical (e.g., drug), and gene. These can be grouped into four different pairings: chemical-disease, chemical-gene, gene-gene, and gene-disease. It is of course possible to identify different types of named entities within the corpus of documents 106 and to create different pairings.

The following table shows illustrative entity pair relationship classes (themes) for the four pairings of entities identified above. The specific relationship classes that are available for a pair of entities may be identified through any number of techniques including manual enumeration such as by an expert considering types of potential relationships that are possible, automatic NLP such as through clustering of linguistically similar sentences to identify a number of discrete clusters that each represents a particular type of relationship, a combination of both, or some other technique.

TABLE 1
Overview of illustrative entity pair relationship classes with corresponding reference codes.

| Chemical-Disease | Chemical-Gene | Gene-Gene | Gene-Disease |
|---|---|---|---|
| (T) treatment/therapy | (A+) agonism, activation | (B) binding, ligand | (Md) biomarkers |
| (including investigatory) | | | (diagnostic) |
| (Sa) side effect | (A−) antagonism, | (W) enhances response | (X) overexpression in |
| | blocking | | disease |
| (C) inhibits cell growth | (B) binding, ligand | (B+) activates, | (L) improper regulation |
| | | stimulates | linked to disease |
| (Pr) prevents, suppresses | (E+) increases | (E+) increases | (U) causal mutations |
| | expression/production | expression/production | |
| (Pa) alleviates, reduces | (E−) decreases | (E−) decreases | (Ud) mutations affecting |
| | expression/production | expression/production | disease course |
| (J) role in disease | (N) inhibits | (I) signaling pathway | (D) drug targets |
| pathogenesis | | | |
| (Mp) biomarkers (of | (O) transport, channels | (H) same protein or | (J) role in pathogenesis |
| disease progression) | | complex | |
| | (K) metabolism, | (Rg) regulation | (Te) possible therapeutic |
| | pharmacokinetics | | effect |
| | (Z) enzyme activity | (Q) production by cell | (Y) polymorphisms alter |
| | | population | risk |
| | | | (G) promotes |
| | | | progression |

Biomedical relation classification plays an important role in the knowledge graph construction pipeline. The relation classification model 102 can, for each sentence obtained from the corpus of documents 106 that includes named entities, analyze the words in the sentence to determine which of the possible relationship types is described. Thus, the relation classification model 102 is not uncovering new categories of relationships or trying to come up with a type of relationship from scratch, rather it is determining the likelihood or probability that the sentence describes each of the multiple different predetermined classes of relationships. For many sentences, the probability of most of the categories will be close to zero while it will be higher for one (or if there is ambiguity) a few of the predetermined relationship classes.

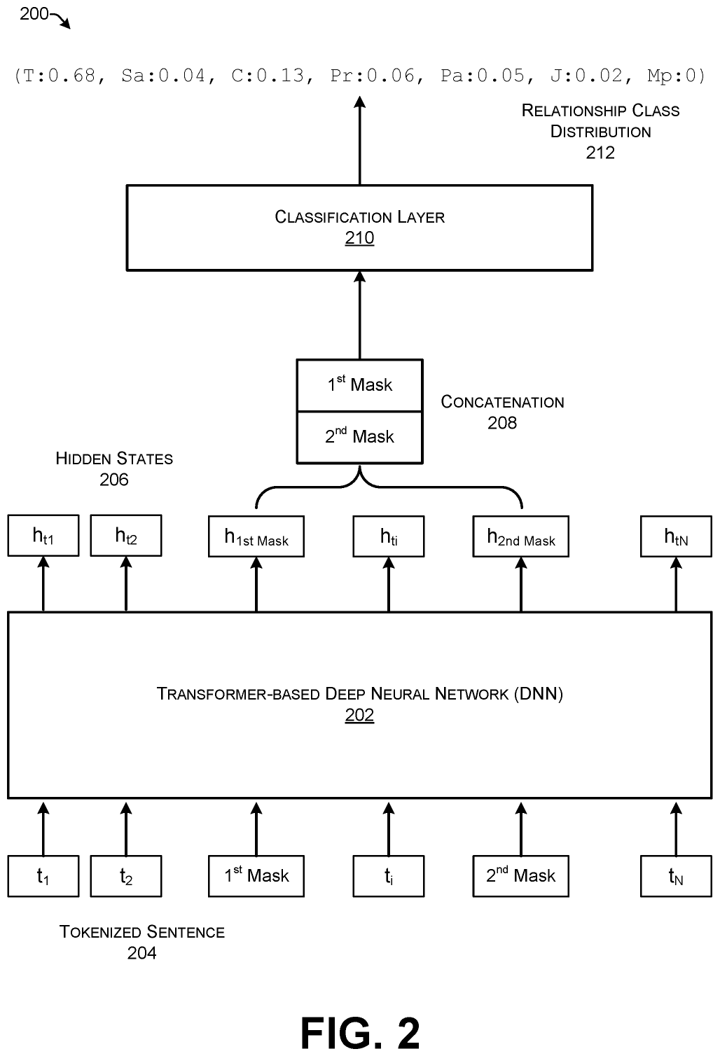

Thus, the relation classification model 102 is solving a multi-class classification problem. Consider a sentence that includes a chemical and a disease. The sentence is analyzed by the relation classification model 102 to determine how likely it represents each of the seven different classes identified in the table above. This can be repeated for some or all of the sentences in the corpus of documents 106 that contain named entities. In some implementations, it may be limited to only those sentences that contain two named entities. If there is only a single named entity, it may not be possible to identify a relationship with another named entity from that sentence alone. However, relationships and interrelationships with sentences that contain three or more named entities may also be identified in some implementations of the relation classification model 102. Additional details of the relation classification model 102 are provided in the description accompanying FIG. 2.

The knowledge graph 104 is built from these relationships identified between the named entities. As mentioned above, each name entity becomes a node in the knowledge graph 104 and relationships between that name entity and other named entities are represented as edges. The knowledge graph 104 is not necessarily limited to representing only a single type of relationship between two entities. The relationship probability for each of the possible relationship classes between the two entities may be stored in the knowledge graph 104. This captures the entirety of the knowledge from the corpus of documents 106 including low probability relationships.

In some implementations, building the knowledge graph 104 involves finding relationship class distribution between all connected entities identified in the corpus of documents 106. Two entities may be defined as connected if there is at least one sentence in the corpus of documents 106 in which the two entities appear together. If there are no such sentences anywhere in the corpus of documents 106, the two entities are considered disconnected.

To find the relationship class distribution of two entities, all sentences that contain those two entities are considered. The probabilities of different classes of relationship represented by each sentence is identified by the relation classification model 102. Depending on how the two entities (e.g., a chemical and a disease) are discussed in the corpus of documents 106, there may be multiple different types of relationships identified with varying probabilities. These range of probabilities across all of the predetermined relationship classes are aggregated over all of the sentences with those entities found in the corpus of documents 106. This creates an aggregate or overall relationship class distribution representing how the two entities are described across all of the documents contained in the corpus of documents 106. Any suitable technique may be used for combining or aggregating the relationship class distributions from multiple individual sentences. In one implementation, micro-averaging is used to calculate a final relationship class distribution for an entity pair. Micro-averaging computes metrics by aggregating counts across all classes, treating each instance equally.

The final relationship class distributions for each connected pair of entities are recorded in the knowledge graph 104. Thus, the knowledge graph 104 contains nodes representing all of the entities identified in the corpus of documents 106 with weighted edges between all connected entities. The weights of the edges indicate the strength or probability of the connection and each edge is also labeled with one of the corresponding relationship classes for that type of entities. Knowledge graph 104, although referred to as a graph, is typically not stored in graphical form but may be any one of a number of different types of data structures that can represent relationships between items. For example, the knowledge graph 104 may be stored as a matrix where the rows are pairs of entities and the columns are the relationship classes that connect the entity pairs. The data structure of the knowledge graph 104 is used to facilitate access to the data in the corpus of documents 106 and for execution of structured queries.

Knowledge graph 104 can receive a query 112 asking about relationships between any one or more entities in the knowledge graph 104. For example, a query may provide a chemical and ask which diseases that chemical can be used to treat. The knowledge graph 104 would then be used to identify all diseases that are connected to that chemical by the relationship class of treatment. The results obtained from the knowledge graph 104 are provided as an answer 114. The answer 114 may present data that is filtered or ordered rather than simply the raw data contained within the knowledge graph 104. For example, the answer 114 may include only the top five diseases with strongest connection to the chemical as treatments. Alternatively, only those diseases for which the connection to the chemical as a treatment is about a threshold weight (e.g., >0.6) could be returned in the answer 114.

Thus, the knowledge graph 104 is a data structure that structures and organizes relationships between entities present in the corpus of documents 106. Use of the knowledge graph 104 makes it possible for a user to receive an answer 114 that could not readily be obtained by directly querying the corpus of documents 106. Moreover, the query 112 and the answer 114 may be submitted from a user device that is located remote from a computing device that stores the knowledge graph 104. By sending only the answer 114-rather than the entirety of the knowledge graph 104 or the corpus of documents 106—to the user device there is a savings of both bandwidth for transmissions over a network and for storage on the user device.

FIG. 2 is a diagram 200 showing the architecture of the relation classification model 102 introduced in FIG. 1. The architecture of the relation classification model 102 includes a transformer-based DNN 202. The DNN 202 uses the well-known transformer architecture described in Vaswani, Ashish et al., Attention Is All You Need, Advances in Neural Information Processing Systems 30 (2017) that has proven successful for many NLP tasks. In one implementation, the DNN 202 is a general large language model that is trained on general-domain texts such as Devlin, Jacob et al., BERT: Pre-training of deep bidirectional transformers for language understanding, 4171 In Proceedings of the 2019 Conference of the North American Chapter of the Association for Computational Linguistics 1 (2019). In another implementation, the DNN 202 is a general-domain large language model modified by transfer learning with domain-specific text. The domain-specific text will be material that is in the same subject matter domain, e.g., biomedicine, as the documents in the corpus of documents 106.

In yet another implementation, the DNN 202 is specifically trained on domain-specific text that is from the same subject matter area as the corpus of documents 106. One example of a DNN 202 pre-trained exclusively on biomedical text is PubMedBert that is described in Gu, Yu et al., Domain-Specific Language Model Pretraining for Biomedical Natural Language Processing, 3 ACM Trans. Comput. Healthcare Appl. 1 (2021). PubMedBERT is a domain-specific language model. PubMedBERT is pretrained solely on biomedical text including scientific articles, abstracts, and clinical notes. The base architecture of PubMedBERT remains the same as BERT, with transformer layers and attention mechanisms. In this implementation, even though the DNN 202 is trained on domain-specific text it may be further fined-tuned.

The DNN takes a tokenized sentence 204 as input. However, the words in the sentences that are named entities as identified by NER are replaced with masks. In this context a mask is a special type of token that represents one of the types of named entities without identifying the specific entity. Thus, if the named entities are, for example, chemical, disease, and gene, all instances of chemicals, diseases, and genes in the sentences would be replaced with the corresponding masks. For example, the sentence “Our experiments provide strong evidence that aspirin is a promising treatment option for patients with headaches.” would become “Our experiments provide strong evidence that C_MASK is a promising treatment option for patients with D_Mask.” The replacement of named entities with masks can be done at both training and inference so that the behavior of the relation classification model 102 depends only on the other words in a sentence. Thus, each sentence is represented as a sequence of tokens S=(t₁, t₂, . . . , C_MASK, . . . , tᵢ, . . . . D_MASK, . . . , t_{N}). As mentioned above, the sentences that are provided to the DNN 202 may be limited to only those sentences from the corpus of documents 106 that include more than one named entity (i.e., avoiding sentences that do not show a relationship between multiple entities) or that include only two named entities (i.e., avoid more complex sentences that include three or more named entities).

The output of the DNN 202 is a collection of hidden states 206 that represents a token from the tokenized sentence 204 in the context of the entire sentence. Thus, hu is a hidden state created from token t₁, hist Mask is a hidden state created from 1st Mask token, and so forth. Each hidden state is a high-dimensional vector that captures the meaning of the original token in context. These vectors are often referred to as embeddings. Note that because the hidden states are influenced by all the tokens of the tokenized sentence 204, the hist Mask and h2nd Mask are embeddings that contain information from the entire input sentence.

The final layer hidden representation of the masked entities is concatenated to create a concatenation 208. For example, the concatenation 208 may be a concatenation of the vector for hand Mask appended to the end of the vector for hist Mask. In one implementation, the vectors are concatenated in the order that the masked entities appear in the sentence. FIG. 2 illustrates a sentence that includes two masked entities, however, if the sentence includes more than two masked entities a corresponding number of hidden states will be concatenated to create the concatenation 208.

The concatenation 208 is passed to a classification layer 210 comprising an activation function. The classification layer 210, in the context of multi-class classification, is used to transform raw model outputs into meaningful class probabilities. If represented as decimal probabilities, the total of the probabilities for all classes will add up to 1.0. Thus, the probability for each class can be interpreted as a confidence score that the relationship represented by the input sentence is properly assigned to that relationship class.

The activation function in the classification layer 210 may be any suitable activation function. For example, the activation function may be a softmax function. The softmax function converts logits (raw scores) into probabilities. Other activation functions that could be used besides the standard softmax include the log-Taylor softmax loss, soft-margin softmax, and sparse-softmax. The log-Taylor softmax loss is a member of the spherical family of loss functions and has been shown to be a superior alternative to the softmax function in some applications. Another alternative is the soft-margin softmax (SM-softmax), which enhances the discriminative nature of the softmax function. In addition, sparse-softmax is a simpler and faster alternative to the standard softmax.

The classification layer 210 provides a relationship class distribution 212. The relationship class distribution 212 contains the probabilities that the relationship between the named entities in the input sentence is correctly classified into each of the predetermined relationship classes. In this example, the relationship class distribution 212 represents the possible relationships between a chemical and a disease as shown in Table 1 above. Specifically, the relationship class distribution 212 is (T: 0.68, Sa: 0.04, C: 0.13, Pr: 0.06, Pa: 0.05, J: 0.02, Mp: 0) indicating that the relationship is probably “(T) treatment” but there is a smaller probability of it being “(C) inhibits cell growth.” The relationship class distribution 212 may be stored as a vector. In this example it would be a 1×7 vector because there are seven predetermined relationship classes for chemicals and diseases.

In one implementation, there is a different relation classification model 102 for each pair of named entities. For example, as shown in Table 1, the types of entity relationships that may be considered are chemical-disease, chemical-gene, gene-gene, and gene-disease. A greater or lesser number and different groups may be used. Thus, in this differentiated design there will be a different model each with its own DNN 202 and classification layer 210 for each of the entity pairs under consideration. For the entity pairs shown in Table 1 there would be four different models. In practice, the NER step will identify the named entities in a sentence and that determination will be used to decide the appropriate model for calculating a relationship class distribution 212.

However, in another implementation the models may be combined into an integrated design. Thus, a single relation classification model 102 with the same DNN 202 and classification layer 210 is used to process all sentences regardless of which named entities are included in the input sentence.

For either implementation, differentiated or integrated, training may be performed with the DNN 202 frozen and only weights of the classification layer 210 updated. The weights of the classification layer 210 can be initialized randomly and updated during training. The training process adjusts the classifier weights to minimize a loss function, which measures the difference between a predicted relationship class distribution 212 and an actual relationship class distribution. The training process alters the relation classification model 102 by updating the classifier weights to improve the model's accuracy.

Any suitable loss function may be used for training. One suitable loss function is the Kullback-Leibler (KL) divergence loss function. This loss function is a measure of how different two probability distributions are from each other and can be used in deep learning to train models that generate probability distributions over classes. Specifically, it measures the difference between the predicted distribution and the true distribution in terms of information content. The KL-divergence loss function can be used to train a deep neural network by minimizing the difference between the predicted and true distributions. This helps the model learn to classify inputs into the correct class. The KL-divergence loss function is often used in conjunction with a softmax activation function to produce class probabilities. Examples of other loss functions that may be used include multi-class cross-entropy loss and sparse multiclass cross-entropy loss.

The training data is labeled training data. The labels may be assigned manually by human experts identifying the type of relationship described in a sentence. Labels may also be assigned automatically by NLP/ML techniques. One source of labeled training data is previous techniques used for biomedical relationship classification. For example, relation class distribution 212 generated by the Global Network of Biomedical Relationships (GNBR) as described in Bethany Percha, B. & Altman, R., A global network of biomedical relationships derived from text, 34 (15) Bioinformatics 2614 (2018) may be used. However, this is but one potential source of training data. In some instances, the training data may include a vector of probabilities so the training task becomes comparing a predicted vector of probabilities with the vector of probabilities in the training data. Even manually labeled relationships can be represented as a vector of probabilities with 1.0 for the relationship identified by the human and 0.0 for all other relationship classes.

### Illustrative Methods

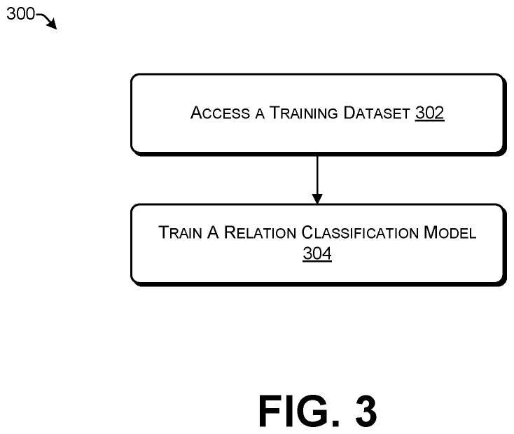

FIG. 3 is a flow diagram of an illustrative method 300 for training a relation classification model. The relation classification model may be the same as the relation classification model shown in FIG. 1 and FIG. 2.

At operation 302, a training data set is accessed. The training data set is formed from a corpus of training documents. The training documents may all be related to the same type of subject matter such as, but not limited to, biomedical texts. The training documents may come originally from an existing database or repository of documents such as PubMed. In some implementations, the training documents are separated into sentences by performing sentence segmentation. The sentence segmentation generates a plurality of training sentences.

Each training sentence may include named entities identified by NER. For example, if the training documents are biomedical texts the named entities may be genes, chemicals, and diseases. Other categories of named entities may be used. Thus, sentences from the training documents that do not include any named entities may be excluded from the training data set. In some implementations, only sentences that include a pair (i.e., two) named entities are used in the training data set. Thus, sentences that include zero, one, three, or more named entities would be excluded from the training data set.

The named entities may be replaced by masks in the training data set. The masks are tokens that represent one of the types of named entities. For example, every mention of a gene in the training sentences may be replaced by a token G_Mask to represent a gene.

The training data set may also include a training relationship class distribution for each of the sentences. The training relationship class distribution is a relationship class distribution included as a label in the training data set. The relationship class distribution is a plurality of probabilities that a relationship between the named entities in one of the training sentences is classified in each of a predetermined number of relationship classes. Examples of possible relationship classes are shown in Table 1. In some implementations, the training relationship class distribution is a vector that includes a probability score for each of the possible relationship classes that could be represented by the training sentence. In some implementations, the training relationship class distribution may indicate a probability of 1 for one relationship class and a probability of 0 for all other relationship classes. This is the same as unambiguously labelling a training sentence as being classified in a single relationship class. The labels may be applied to the training sentences either manually by a human or automatically using NLP and ML techniques.

At operation 304, the relation classification model is trained using the training data set. As described above, the relation classification model comprises a transformer-based DNN architecture with a classification layer. The relation classification model learns weights to classify a relationship between the named entities into one or more of the predetermined number of relationship classes. In some implementations the DNN comprises a BERT architecture pretrained on biomedical texts. BERT is a transformer-based architecture for NLP tasks. It consists of an embedding layer, a stack of encoders, and an un-embedding layer. The embedding layer converts tokens into vectors. The stack of encoders, which varies in size between 12 in BERT BASE and 24 in BERT LARGE, performs transformations on these vectors. Finally, the un-embedding layer is a final layer that converts the vectors back into tokens. BERT's bidirectional nature allows it to consider the entire context of a sentence, a significant shift from previous sequential models. The classification layer comprises an activation function which may be the softmax activation function. However, other activation functions may also be used. The output from the DNN that is passed to the classification layer for training may be only the embeddings that represent the masked named entities. That is, embeddings generated from other words in the training sentences are not passed to the classification layer. The embeddings of the masked named entities are concatenated to create a single vector, a concatenation, that is passed to the classification layer.

The training comprises minimizing a loss function that evaluates the difference between the actual values for the training relationship class distribution and a predicted relationship class distribution generated by the relation classification model. This may be represented as the difference between the target distribution across k target classes as T=(t₁, t₂, . . . , tₖ), and the predicted distribution across k target classes generated by the model as P=(p₁, p₂, . . . , pₖ). Both Σᵢ₌₁^{k} tᵢ=1 and Σᵢ₌₁^{k}pᵢ=1 as they are probability distributions over the k target classes. The loss function may be any suitable loss function for training machine learning models. For example, the KL divergence loss function is one that may be used.

The hyperparameters for training may depend on the particular training data set and the tasks the model is being asked to perform. Persons of ordinary skill in the art will understand how to select hyperparameters for training of a classification model. In one example implementation, training is performed using the KL-divergence loss function with an optimizer with the setup of 81 =0.9, 82=0.999, and €=l-8. In one implementation the AdamW optimizer is used. However, other optimization algorithms, including but not limited to, Stochastic Gradient Descent (SGD), SGD with Nesterov Momentum, RMSProp, Adafactor, and AdamW with bitwise normalization may also be used. Other training parameters include training the models for a maximum of 150 epochs on training data with 100 warm-up steps and a maximum of 10 steps for early stopping in training the models. The batch size may be set to 16, with a gradient accumulation step of 2 to achieve an actual batch size effect of 32. The initial learning rate may be to 5e-5 and run the evaluation of the validation set after each 5000 steps. However, any of these and other hyperparameters may be freely varied. The best-performing model on a validation set based on KL-divergence loss may be selected as the final relation classification model and performance evaluated on a test set. For training, the training data set is divided into train, validation, and test data sets. For example, the training data set may be divided into 80% train, 5% validation, and 10% test sets.

The relationship classification model may be updated at any time by training on a new training data set. For updating, the weights begin as the weights learned from the previous training rather than random weights. The updating proceeds in the same manner as the initial training. Updating may be performed relatively quickly and will lower computational load because the weights begin with values that do not need to be changed as much as the random weights used initially. Also, in some implementations, only weights in the classification layer are trained so the layers of the DNN do not need to be retrained. Training with a new training data set may also introduce new named entities (e.g., a chemical that was not included in the previous training data set).

Following training, the relation classification model is ready to be used at inference time to identify relationships between named entities in a corpus of documents. Those relationships, and the named entities, are then used to create a knowledge graph.

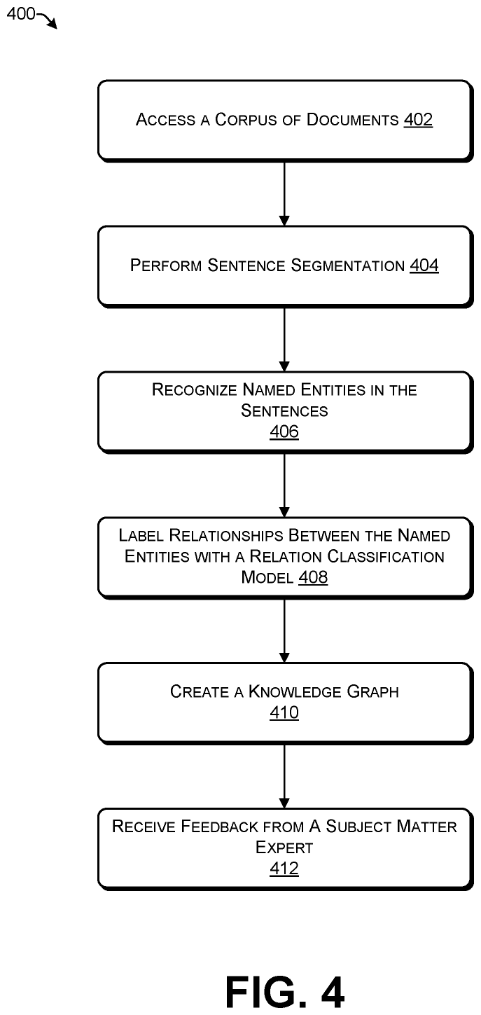

FIG. 4 is a flow diagram of an illustrative method 400 for creating a knowledge graph. The knowledge graph may be the same as the knowledge graph shown in FIG. 1.

At operation 402, a corpus of documents is accessed. The corpus of documents may be the same as the corpus of documents 106 introduced in FIG. 1. For example, the corpus of documents could comprise biomedical texts such as PubMed. It is to be understood that the corpus of documents could also comprise documents related to any type of subject matter.

At operation 404, sentence segmentation is performed on the corpus of documents.

Sentence identification identifies sentences in the corpus of documents. The sentence segmentation may be performed by any current or later developed technique for sentence segmentation.

At operation 406, named entities are recognized in individual ones of the sentences. The named entities may be determined in advance based on the subject matter of the corpus of documents. For biomedical documents, the named entities may be, but are not limited to, gene, chemical, and disease. Named entity recognition may be performed by any current or later developed NER technology. In some implementations, recognizing named entities comprises recognizing a pair of named entities in each of the individual ones of the sentences.

At operation 408, relationships between the named entities are labeled with a relation classification model. This may be the same relation classification model 102 in FIG. 1. The labeling generates a predicted relationship class distribution across a predetermined number of relationship classes. Examples of relationship classes are shown in Table 1. As described above, the relationship classification model may comprise a transformer-based DNN architecture with a classification layer. The predicted relationship class distribution may be generated as a vector that stores decimal probability values for each of the predetermined number of relationship classes.

Labeling the relationships between the named entities may be done by masking the named entities in the sentences before providing the sentences to the relation classification model. Then embeddings generated from the masks of the named entities are concatenated and the concatenation is passed to the classification layer.

At operation 410, the knowledge graph is created. The knowledge graph is a traceable and descriptive network with directional, labeled, weighted edges. For the named entities found in a same sentence, the knowledge graph stores the predicted relationship class distribution over the corresponding relationship classes. The predicted relationship class distribution between named entities in the knowledge graph is created by aggregating the individual relationship class distribution in each of individual ones of the sentences that contain the named entities. There are multiple ways to aggregate relationship class distributions (e.g., aggregate, average, or combine multiple vectors of decimal probabilities). One technique that may be used is micro-averaging.

The knowledge graph can be implemented with many different potential data structures. One type of data structure that can be used is a comma-separated file. Each row of the file can contain information about one entity pair. Specifically, each row could include source entity id, tail entity id, relationship type, and relationship score (i.e., probability the relationship type is correct). There can also be different knowledge graphs created for each combination of named entities. Thus, there may be a chemical-disease knowledge graph, a chemical-gene knowledge graph, a gene-gene knowledge graph, and a gene-disease knowledge graph.

At operation 412, feedback is received from a subject matter expert and the knowledge graph is adjusted. The expert may identify misclassified relationships or misidentified named entities. Correction received from the expert related to misclassified relationships can be used as labels for further training of the relation classification model. The corrected information based on the expert's feedback can be used for a subsequent round of training the model. Errors in the recognition of named entities can also be provided to the NER tool which may simply update the tool by modifying linear programming or, if it is based on machine learning, through additional training.

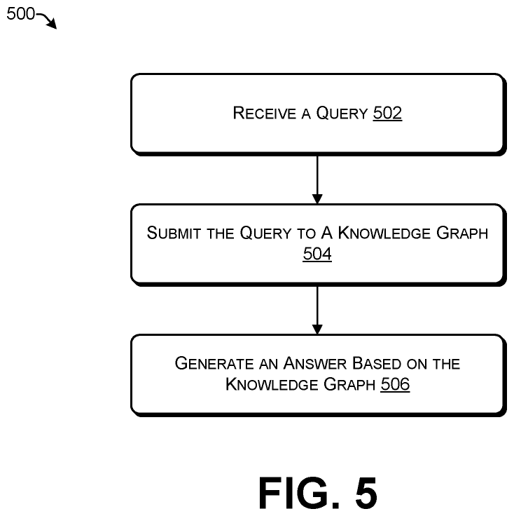

FIG. 5 is a flow diagram of an illustrative method 500 for querying information stored in a corpus of documents. The corpus of documents may be the same as a corpus of documents shown in FIG. 1. For example, the corpus of documents may comprise biomedical texts.

At operation 502, a query is received. The query may be received from a user device operated by a user seeking an answer to the query. The query may be transmitted across a limited bandwidth network to the device that stores the knowledge graph as a data structure. The query is related to a first named entity. That is, the query includes at least one named entity such as a chemical, disease, or gene. The query can also include a second named entity which may also be one of a chemical, disease, or gene. However, these are merely illustrative types of named entities. For example, the query may ask: “How are gene 1 and gene 2 related?” Alternatively, the query may include a relationship class with the first named entity. For example, the query may ask: “What are treatments for Covid-19?” More complex queries are also possible such as queries that include a first named entity, a second named entity, and a relationship class.

At operation 504, the query is submitted to a knowledge graph. Submitting the query to the knowledge graph may include receiving the query at a computing device, such as an application server, that maintains the knowledge graph and other components for accessing the knowledge graph. The knowledge graph is created as described previously and represents named entities identified in the plurality of documents as nodes and the relationships between the named entities as edges.

At operation 506, an answer is generated based on the knowledge graph. The result may be generated by searching a data structure that contains the information contained in the knowledge graph. Techniques for using knowledge graphs to generate answers to queries are known to those of ordinary skill in the art. For example, if the query includes a first named entity and a second named entity, the answer can identify the relationship between the first named entity and the second named entity. This relationship is discovered by examining the relationship class represented by an edge connecting the first named entity to the second named entity in the knowledge graph. The answer may be only a single type of relationship, it may return the relative probabilities of all the possible relationship classes, it may only return those relationship classes that have more than a threshold probability (e.g., 0.6) of being correct, or it may filter or modify the raw data from the knowledge graph in some other way.

As another example, if the query includes a first named entity and a relationship class, the answer can identify one or more named entities that have the specified type of relationship with the first named entity. These other named entities may be identified from the knowledge graph because they are connected to the first named entity by edges representing the relationship class. This could include all the chemicals connected to the node for the disease Covid-19 by an edge that represents the relationship class of treatment. In some implementations, filtering of the raw data from the knowledge graph may be applied to limit what is returned in the answer. For example, only those edges above a certain threshold weight or probability may be included in the answer. Thus, only chemicals connected by an edge indicating a treatment relationship with Covid-19 above some threshold weight would be returned.

The result may be only a single sentence or list of named entities. Thus, the result itself generally needs much less data to be conveyed than the documents (or even the sentences from those documents) on which that information in the result is gathered. For example, a list of ten chemicals that could be used to treat Covid-19 needs much less data to be conveyed than all the documents that describe those treatments. Thus, querying a knowledge graph rather than receiving and reviewing multiple documents not only saves the user's time but uses less data than transmitting the documents from which the information contained in the result was derived. Reducing the amount of data transmitted over a network can be especially beneficial when using a limited bandwidth network, as may be the case with a mobile device. This also reduces memory and storage requirements on the user device.

Moreover, because the result obtained from the knowledge graph is a summary or condensation of information spread out over multiple documents in the corpus of documents, the result can be presented to a user in its entirety on a device that has a small screen such as a handheld device. Even if the same information could be provided to a user by providing all of the original documents, it may be impractical or impossible to display those documents on a small screen. Providing only the result rather than the entirety of the documents allows the sought-after information to be conveyed on a small screen. Similarly, providing concise results obtained from a knowledge graph also allows the result to be provided over an audio output device such as a smart speaker that does not have a screen.

### Illustrative Computing Architectures and Environments

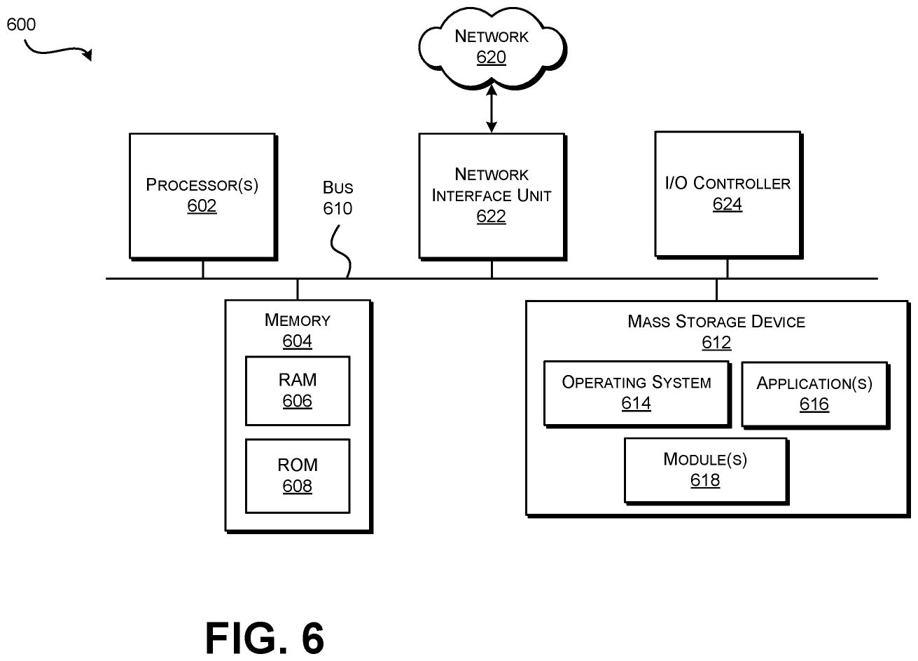

FIG. 6 shows details of an example computer architecture 600 for a device, such as a computer or a server configured as part of a cloud-based platform, capable of executing computer instructions (e.g., a module or a component described herein). The computer architecture 600 illustrated in FIG. 6 includes one or more processor(s) 602, a system memory 604, including a random-access memory 606 (“RAM”) and a read-only memory (“ROM”) 608, and a system bus 610 that couples the memory 604 to the processors(s) 602. The processor(s) 602 may also comprise or be part of a processing system. In various examples, the processor(s) 602 of the processing system are distributed. Stated another way, one processor(s) 602 of the processing system may be located in a first location (e.g., a rack within a datacenter) while another processor(s) 602 of the processing system is located in a second location separate from the first location.

The processor(s) 602, which may also be referred to as a processing unit(s), can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in ROM 608. The computer architecture 600 further includes a mass storage device 612 for storing an operating system 614, application(s) 616, modules/components 618, and other data described herein. The operating system 614, application(s) 616, and modules/components 618 may comprise computer-executable instructions implemented by the processor(s) 602. The application(s) 616 may include the relation classification model 102 introduced in FIG. 1. The mass storage device 612 may also store the knowledge graph 104 as well as applications for querying the knowledge graph 104 and receiving answers. The module(s) 618 may include modules for building or training machine learning applications such as sentence segmentation software (e.g., BlingFire), NER software (e.g., PubTator), and an optimizer module (e.g., AdamW).

The mass storage device 612 is communicatively connected to processor(s) 602 through a mass storage controller connected to the bus 610. The mass storage device 612 provides non-volatile storage for the computer architecture 600. It should be appreciated by those skilled in the art that the mass storage device 612 can be any available computer-readable storage medium or communications medium that can be accessed by the computer architecture 600. The mass storage device 612 is a type of memory. Anything shown as stored in the mass storage device 612 may alternatively be stored on another computing device such as one accessible via the network 620.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static random-access memory (SRAM), dynamic random-access memory (DRAM), phase-change memory (PCM), ROM, erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network-attached storage, storage area networks, hosted computer storage or any other storage memory, storage device, and/or storage medium that can be used to store and maintain information for access by a computing device.

In contrast to computer-readable storage media, communication media embodies computer-readable instructions, data structures, program modules, or other data in a modulated data signal, such as a carrier wave, or other transmission mechanism. As defined herein, computer-readable storage medium does not include communication medium. That is, computer-readable storage media does not include communications media and thus excludes media consisting solely of a modulated data signal, a carrier wave, or a propagated signal, per se.

According to various configurations, the computer architecture 600 may operate in a networked environment using logical connections to remote computers through a network 620. The computer architecture 600 may connect to the network 620 through a network interface unit 622 connected to the bus 610. The respective interfaces may also contain software components on multiple logical levels for constructing interfaces between computer components as is understood by those of ordinary skill in the art. An I/O controller 624 may also be connected to the bus 610 to control communication in input and output devices.

It should be appreciated that the software components described herein may, when loaded into the processor(s) 602 and executed, transform the processor(s) 602 and the overall computer architecture 600 from a general-purpose computing system into a special-purpose computing system customized to facilitate the functionality presented herein. The processor(s) 602 may be constructed from any number of transistors or other discrete circuit elements, which may individually or collectively assume any number of states. More specifically, the processor(s) 602 may operate as a finite-state machine, in response to executable instructions contained within the software modules disclosed herein. These computer-executable instructions may transform the processor(s) 602 by specifying how the processor(s) 602 transitions between states, thereby transforming the transistors or other discrete hardware elements constituting the processor(s) 602.

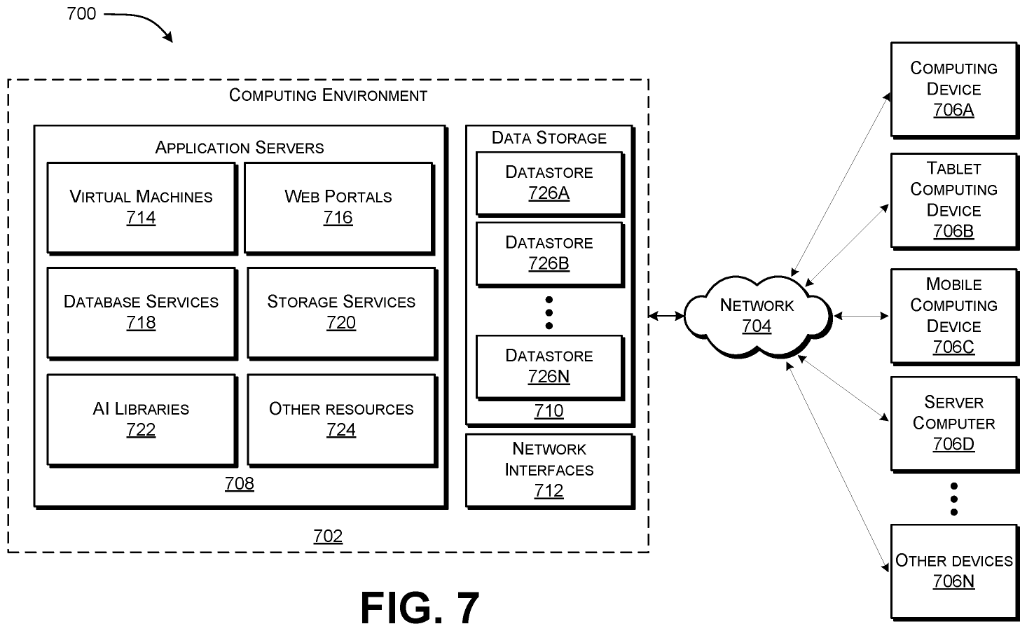

FIG. 7 depicts an illustrative distributed computing environment 700 capable of executing the software components described herein. Thus, the distributed computing environment 700 illustrated in FIG. 7 can be utilized to execute any aspects of the software components presented herein.

According to various implementations, the distributed computing environment 700 includes a computing environment 702 operating on, in communication with, or as part of the network 704. One or more client devices 706A-706N (hereinafter referred to collectively and/or generically as “clients 706” and also referred to herein as computing devices or user devices can communicate with the computing environment 702 via the network 704. The network 704 may be the same as the network 620 shown in FIG. 6.

In one illustrated configuration, the clients 706 include a computing device 706A such as a laptop computer, a desktop computer, or other computing device; a slate or tablet computing device (“tablet computing device”) 706B; a mobile computing device 706C such as a mobile telephone, a smartphone, or other mobile computing device; a server computer 706D; and/or other devices 706N. It should be understood that any number of clients 706 can communicate with the computing environment 702. The clients 706 may be examples of the types of computing devices that submit a query to the knowledge graph in order to receive an answer.

In the illustrated configuration, the computing environment 702 includes application servers 708, data storage 710, and one or more network interfaces 712. According to various implementations, the functionality of the application servers 708 can be provided by one or more server computers that are executing as part of, or in communication with, the network 704. The application servers 708 can host various services, virtual machines, portals, and/or other resources. In the illustrated configuration, the application servers 708 host one or more virtual machines 714 for hosting applications or other functionality. According to various implementations, the virtual machines 714 host one or more applications and/or software modules for implementing aspects of the functionality disclosed herein. It should be understood that this configuration is illustrative and should not be construed as being limiting in any way. The application servers 708 can also host or provide access to one or more portals, link pages, Web sites, and/or other information (“web portals”) 716.

According to various implementations, the application servers 708 also include one or more database services 718 and one or more storage services 720. The database services 718 can include access to a corpus of documents such as PubMed. The storage services 720 can include, but are not limited to, services that remotely store data for access on a client 706 such as OneDrive by Microsoft®.

The application servers 708 also may include one or more AI libraries 722. An AI library is a comprehensive toolkit that provides pre-built functions and structures for designing, training, and validating complex neural network models, thereby simplifying, and accelerating the development of machine learning projects. The AI libraries 722 can include, but are not limited to, TensorFlow, PyTorch, Keras, Hugging Face, Theano, Caffe, and Microsoft CNTK.

As shown in FIG. 7, the application servers 708 also can host other services, applications, portals, and/or other resources (“other resources”) 724. The other resources 724 can include, but are not limited to, mapping, machine learning, query analysis, rendering or any other functionality. It thus can be appreciated that the computing environment 702 can provide integration of the concepts and technologies disclosed herein with various webpages, databases, storage, AI libraries, and/or other services or resources.

As mentioned above, the computing environment 702 can include the data storage 710. According to various implementations, the functionality of the data storage 710 is provided by one or more databases operating on, or in communication with, the network 704. The functionality of the data storage 710 also can be provided by one or more server computers configured to host data for the computing environment 702. The data storage 710 can include, host, or provide one or more real or virtual datastores 726A-726N (hereinafter referred to collectively and/or generically as “datastores 726”). The datastores 726 are configured to host data used or created by the application servers 708 and/or other data. Although not illustrated in FIG. 7, the datastores 726 also can host or store web page documents, word processing documents, search queries, data structures such as one or more knowledge graphs, algorithms for execution by a knowledge graph query engine, and/or other data utilized by any application program or another module. Aspects of the datastores 726 may be associated with a service for storing data units such as files.

The other resources 724 may include one or more database management systems for managing the datastores 726. The database management systems technical systems implemented in the computing environment 702 to perform the technical tasks of storing and retrieving data using various data structures for efficient management of data. One type of data structure that may be used by the database management system is a knowledge graph. Accordingly, methods that describe use of the knowledge graph are methods performed in a database management system using technical means. The data structures, including the knowledge graphs, are used in the database management systems to facilitate access to data or for the execution of structured queries. Examples of structures queries include queries to a knowledge graph to identify relationships between nodes defined by the edges connecting those nodes. Such data structures are functional because they purposively control the operation of the database management system to perform technical tasks.

The computing environment 702 can communicate with, or be accessed by, the network interfaces 712. The network interfaces 712 can include various types of network hardware and software for supporting communications between two or more computing devices including, but not limited to, the computing devices and the servers. It should be appreciated that the network interfaces 712 also may be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the computing devices. It should also be understood that the computing devices can include real or virtual machines including, but not limited to, server computers, web servers, personal computers, mobile computing devices, smartphones, and/or other devices. As such, various configurations of the concepts and technologies disclosed herein enable any device configured to access the distributed computing environment 700 to utilize the functionality described herein for providing the techniques disclosed herein, among other aspects. In one specific example, as summarized above, techniques described herein may be implemented, at least in part, by a web browser application, which works in conjunction with the application servers 708 of FIG. 7.

### Illustrative Embodiments

The following clauses described multiple possible embodiments for implementing the features described in this disclosure. The various embodiments described herein are not limiting nor is every feature from any given embodiment required to be present in another embodiment. Any two or more of the embodiments may be combined together unless context clearly indicates otherwise. As used herein in this document “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.

Clause 1. A method of creating a relation classification model comprising: accessing a training data set comprising a plurality of training sentences having instances of named entities replaced by masks and, for each one of the training sentences, a training relationship class distribution comprising a plurality of probabilities that a relationship between the named entities in the one of the training sentences is classified in each of a predetermined number of relationship classes; and training the relation classification model using the training data set, the relation classification model comprising a transformer-based deep neural network (DNN) architecture with a classification layer that learns weights to classify a relationship between the named entities into one or more of the predetermined number of relationship classes.

Clause 2. The method of clause 1, wherein the plurality of training sentences are identified by performing sentence segmentation on a plurality of documents.

Clause 3. The method of any of clauses 1-2, wherein the training data set comprises biomedical texts and the named entities each independently represent one of a gene, a chemical, or a disease.

Clause 4. The method of any of clauses 1-3, wherein the training minimizes KL-divergence loss.

Clause 5. The method of any of clauses 1-4, wherein the DNN comprises a BERT architecture pretrained on biomedical text.

Clause 6. The method of any of clauses 1-5, wherein the classification layer comprises a softmax activation function.

Clause 7. The method of any of clauses 1-6, wherein training the relation classification model comprises concatenating embeddings representing the named entities replaced by masks from a final layer of the DNN and passing the concatenation to the classification layer.

Clause 8. A method of creating a knowledge graph comprising: accessing a corpus of documents; performing sentence segmentation on the corpus of documents to identify sentences in the corpus of documents; recognizing named entities in individual ones of the sentences; labeling relationships between the named entities in the individual ones of the sentences with a relation classification model that generates a predicted relationship class distribution across a predetermined number of relationship classes, the relation classification model comprising a transformer-based deep neural network (DNN) architecture with a classification layer trained on a training data set comprising a plurality of training sentences having instances of the named entities replaced by masks and, for each one of the training sentences, a training relationship class distribution comprising a plurality of probabilities that a relationship between the named entities in the one of the training sentences is classified in each of the predetermined number of relationship classes; and creating the knowledge graph that stores the predicted relationship class distribution between the named entities found in a same sentence.

Clause 9. The method of clause 8, wherein the corpus of documents comprises biomedical texts and the named entities each independently represent one of a gene, a chemical, or a disease.

Clause 10. The method of any of clauses 8-9, wherein recognizing the named entities comprises recognizing a pair of named entities in each of the individual ones of the sentences.

Clause 11. The method of any of clauses 8-10, wherein creating the knowledge graph comprises aggregating relationship class distributions across all the sentences that contain the named entities.

Clause 12. The method of any of clauses 8-11, wherein the knowledge graph is a traceable and descriptive network with directional, labeled, weighted edges.

Clause 13. The method of any of clauses 8-12, wherein labeling the relationships between the named entities comprises masking the named entities and concatenating embeddings representing masks of the named entities from a final layer of the DNN and passing the concatenation to the classification layer.

Clause 14. The method of any of clauses 8-13, further comprising receiving feedback from a subject matter expert and adjusting the predicted relationship class distribution based on the feedback.

Clause 15. A method of querying information stored in a corpus of documents comprising; receiving a query related to a first named entity and (i) a second named entity or (ii) a relationship class; submitting the query to a knowledge graph representing named entities identified in the corpus of documents as nodes and relationships between the named entities as edges, the knowledge graph created by labeling the relationships between the named entities identified in the plurality of documents with a relation classification model that generates a predicted relationship class distribution across a predetermined number of relationship classes, the relation classification model comprising a transformer-based deep neural network (DNN) architecture with a classification layer trained on a training data set comprising a plurality of training sentences having instances of the named entities replaced by masks and, for each one of the training sentences, a training relationship class distribution comprising a plurality of probabilities that a relationship between the named entities in the one of the training sentences is classified in each of the predetermined number of relationship classes; and generating an answer based on the knowledge graph that identifies (i) the relationship class represented by an edge connecting the first named entity to the second named entity or (ii) one or more named entities that are connected to the first named entity by edges representing the relationship class.

Clause 16. The method of clause 15, wherein the query is received across a limited bandwidth network and transmitting the answer uses less data than transmitting documents from which the information contained in the answer was derived.

Clause 17. The method of any of clauses 15-16, wherein the corpus of documents comprises biomedical texts and the first named entity and the second named entity each independently represent one of a gene, a chemical, or a disease.

Clause 18. The method of any of clauses 15-17, wherein transformer-based deep neural network (DNN) architecture comprises a BERT architecture and the classification layer comprises a softmax activation function.

Clause 19. The method of any of clauses 15-18, wherein the method comprises: receiving a query related to a first named entity and a second named entity; and generating the answer based on the knowledge graph that identifies the relationship class represented by an edge connecting the first named entity to the second named entity.

Clause 20. The method of any of clauses 15-19, wherein the method comprises: receiving a query related to a first named entity and a relationship class; and generating the answer based on the knowledge graph that identifies one or more named entities that are connected to the first named entity by edges representing the relationship class.

Clause 21. A system comprising a processor and a memory storing instructions that cause the system to perform the method of any of clauses 1 to 20.

Clause 22. Computer-readable storage media comprising instructions that, when executed by a computing device, cause the computing device to perform the method of any of clauses 1 to 20.

### CONCLUSION

While certain example embodiments have been described, including the best mode known to the inventors for carrying out the invention, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. Skilled artisans will know how to employ such variations as appropriate, and the embodiments disclosed herein may be practiced otherwise than specifically described. The accompanying claims and their equivalents are intended to cover such forms or modifications as would fall within the scope and spirit of certain of the inventions disclosed herein.

The terms “a,” “an,” “the” and similar referents used in the context of describing the invention are to be construed to cover both the singular and the plural unless otherwise indicated herein or clearly contradicted by context. The terms “based on,” “based upon,” and similar referents are to be construed as meaning “based at least in part” which includes being “based in part” and “based in whole,” unless otherwise indicated or clearly contradicted by context. The terms “portion,” “part,” or similar referents are to be construed as meaning at least a portion or part of the whole including up to the entire noun referenced.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different tools).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Furthermore, references have been made to publications, patents and/or patent applications throughout this specification. Each of the cited references is individually incorporated herein by reference for its particular cited teachings as well as for all that it discloses.

1. A method of creating a relation classification model comprising:
accessing a training data set comprising a plurality of training sentences having instances of named entities replaced by masks and, for each one of the training sentences, a training relationship class distribution comprising a plurality of probabilities that a relationship between the named entities in the one of the training sentences is classified in each of a predetermined number of relationship classes; and
training the relation classification model using the training data set, the relation classification model comprising a transformer-based deep neural network (DNN) architecture with a classification layer that learns weights to classify a relationship between the named entities into one or more of the predetermined number of relationship classes.

2. The method of claim 1, wherein the plurality of training sentences are identified by performing sentence segmentation on a plurality of documents.

3. The method of claim 1, wherein the training data set comprises biomedical texts and the named entities each independently represent one of a gene, a chemical, or a disease.

4. The method of claim 1, wherein the training minimizes KL-divergence loss.

5. The method of claim 1, wherein the DNN comprises a BERT architecture pretrained on biomedical text.

6. The method of claim 1, wherein the classification layer comprises a softmax activation function.

7. The method of claim 1, wherein training the relation classification model comprises concatenating embeddings representing the named entities replaced by masks from a final layer of the DNN and passing the concatenation to the classification layer.

8. A method of creating a knowledge graph comprising:
accessing a corpus of documents;
performing sentence segmentation on the corpus of documents to identify sentences in the corpus of documents;
recognizing named entities in individual ones of the sentences;
labeling relationships between the named entities in the individual ones of the sentences with a relation classification model that generates a predicted relationship class distribution across a predetermined number of relationship classes,
the relation classification model comprising a transformer-based deep neural network (DNN) architecture with a classification layer trained on a training data set comprising a plurality of training sentences having instances of the named entities replaced by masks and, for each one of the training sentences, a training relationship class distribution comprising a plurality of probabilities that a relationship between the named entities in the one of the training sentences is classified in each of the predetermined number of relationship classes; and
creating the knowledge graph that stores the predicted relationship class distribution between the named entities found in a same sentence.

9. The method of claim 8, wherein the corpus of documents comprises biomedical texts and the named entities each independently represent one of a gene, a chemical, or a disease.

10. The method of claim 8, wherein recognizing the named entities comprises recognizing a pair of named entities in each of the individual ones of the sentences.

11. The method of claim 8, wherein creating the knowledge graph comprises aggregating relationship class distributions across all the sentences that contain the named entities.

12. The method of claim 8, wherein the knowledge graph is a traceable and descriptive network with directional, labeled, weighted edges.

13. The method of claim 8, wherein labeling the relationships between the named entities comprises masking the named entities and concatenating embeddings representing masks of the named entities from a final layer of the DNN and passing the concatenation to the classification layer.

14. The method of claim 8, further comprising receiving feedback from a subject matter expert and adjusting the predicted relationship class distribution based on the feedback.

15. A method of querying information stored in a corpus of documents comprising;
receiving a query related to a first named entity and (i) a second named entity or (ii) a relationship class;
submitting the query to a knowledge graph representing named entities identified in the corpus of documents as nodes and relationships between the named entities as edges,
the knowledge graph created by labeling the relationships between the named entities identified in the plurality of documents with a relation classification model that generates a predicted relationship class distribution across a predetermined number of relationship classes, the relation classification model comprising a transformer-based deep neural network (DNN) architecture with a classification layer trained on a training data set comprising a plurality of training sentences having instances of the named entities replaced by masks and, for each one of the training sentences, a training relationship class distribution comprising a plurality of probabilities that a relationship between the named entities in the one of the training sentences is classified in each of the predetermined number of relationship classes; and
generating an answer based on the knowledge graph that identifies (i) the relationship class represented by an edge connecting the first named entity to the second named entity or (ii) one or more named entities that are connected to the first named entity by edges representing the relationship class.

16. The method of claim 15, wherein the query is received across a limited bandwidth network and transmitting the answer uses less data than transmitting documents from which the information contained in the answer was derived.

17. The method of claim 15, wherein the corpus of documents comprises biomedical texts and the first named entity and the second named entity each independently represent one of a gene, a chemical, or a disease.

18. The method of claim 15, wherein transformer-based deep neural network (DNN) architecture comprises a BERT architecture and the classification layer comprises a softmax activation function.

19. The method of claim 15, wherein the method comprises:
receiving a query related to a first named entity and a second named entity; and
generating the answer based on the knowledge graph that identifies the relationship class represented by an edge connecting the first named entity to the second named entity.

20. The method of claim 15, wherein the method comprises:
receiving a query related to a first named entity and a relationship class; and
generating the answer based on the knowledge graph that identifies one or more named entities that are connected to the first named entity by edges representing the relationship class.
